(19) United States
(12) Patent Application Publication
(10) Pub. No.: US 2026/0213499 A1
(43) Pub. Date: Jul. 23, 2026

(54) ELECTRODE WITH ELONGATED ELEVATION OR GROOVE, AND A SPARK PLUG COMPRISING SUCH AN ELECTRODE AS A GROUND ELECTRODE

(71) Applicant: Robert Bosch GmbH, Stuttgart (DE)

(72) Inventors: Stefan Pfeiffer, Bamberg (DE); Detlef Hartmann, Bamberg (DE); Jens Gringer, Hirschaid (DE)

(21) Appl. No.: 19/139,419

(22) PCT Filed: Dec. 11, 2023
(86) PCT No.: PCT/EP2023/085154

§ 371 Date: Jun. 16, 2025

(30) Foreign Application Priority Data
Dec. 20, 2022 (DE) 10 2022 214 083.4

(51) Int. Cl. H01T 13/32; H01T 1/22; H01T 13/54; H01T 21/02

(52) U.S. Cl. CPC H01T 13/32; H01T 1/22; H01T 13/54; H01T 21/02

(57) ABSTRACT

An electrode (5) for a spark plug having a base body (50), a longitudinal axis E, an inner end (51) on which an ignition surface is arranged, and an outer end (52) opposite the inner end, wherein the base body (50) has a diameter DG, wherein the electrode (5) has at least one elongated elevation (55) and/or at least one groove (56) on its base body (50).

### BACKGROUND

The invention relates to an electrode for a spark plug and a spark plug with such an electrode as a ground electrode.

For some time, new spark plug concepts have increasingly been pursued in which the ignition gap is formed within the housing. In one of these concepts, the ground electrode is inserted into a bore in the housing wall and projects laterally from the housing wall into the internal space of the housing. A prechamber spark plug is known from DE 10 2017 221 517 A, for example, in which the ground electrode is arranged in a bore housing in the housing wall and projects laterally into the internal space.

With a ground electrode inserted laterally into the spark plug, new challenges arise with respect to correct orientation of the ground electrode for the center electrode and adjustment of the ignition gap as well as reliable fastening of the electrode in the bore. One possible attachment method is to press the ground electrode into the bore. In this technique, a very high manufacturing accuracy of the components is required, so that the electrode is sufficiently tightly pressed in the bore over the life of the spark plug, and on the other hand can be inserted in a controlled manner during assembly so that the electrode spacing can be set as precisely as possible. If the necessary production accuracy is not met, component failures can occur during production. These high demands on manufacturing accuracy make the manufacturing process complex and expensive.

### SUMMARY

The object of the present invention is to provide an electrode and a spark plug in which a reliable correct assembly of the ground electrode is allowed, so that the manufacturing process is simplified.

This object is solved by the electrode and spark plug according to the invention.

The electrode according to the invention for a spark plug has a base body and a longitudinal axis E, which extends from an inner end to an outer end of the base body and the electrode. The ignition surface of the electrode is arranged at the inner end of the electrode and the base body. Accordingly, the inner end faces an ignition gap when the electrode is mounted in a spark plug. The outer end is the end of the electrode opposite the inner end and correspondingly facing away from an ignition gap. The base body has a diameter D_{G}.

Furthermore, the electrode comprises at least one elongated elevation and/or one groove on its base body.

The at least one elongated elevation or the at least one groove results in the advantage that manufacturing tolerance increases and the requirement for manufacturing accuracy decreases, so that the manufacturing process is simplified. When pressing the electrode into a bore on a spark plug, the electrode can plastically form, more specifically, the elevation on the base body or the base body with the groove can plastically deform, so that the electrode can be sufficiently tightly pressed in the bore even with lower manufacturing accuracy. If too much force is applied to the electrode during the pressing process, it can be trapped in the electrode by the plastic deformation without damaging the electrode itself or the bore.

The groove may also be understood as an elongated recess. The base body is cylindrical or conical, for example. For example, the electrode at the inner end of the base body may comprise an element on which an ignition surface is formed.

In a further development, the base body comprises at least two or three or four or five elongated elevations and/or grooves that are evenly arranged along the circumference of the base body. This results in the plastic deformation taking place evenly on the electrode across the circumference of the base body. For example, the electrode has at least two sections along its circumference. In the first section, the electrode has the diameter D_{G} of the base body. In the second section of the electrode, the base body has an elevation or a groove and a diameter D_{R}, which deviates from D_{G} correspondingly, for an elevation and D_{K} for a groove. Measured along the circumference of the base body, the first section is longer than the second section. According to the number of elevations and/or grooves, there are also second sections. There are as many first sections as second sections. As the number of second sections increases, the length of the first sections approaches the length of the second section. At a maximum number of second sections, the first and second sections are the same length.

In another further development, the at least one elevation and/or the at least one groove extend parallel to a longitudinal axis E of the electrode. Alternatively, the at least one elevation and/or the at least one groove extend at an angle of greater than 0° and less than 90°, in particular less than 45°, and further in particular less than 30°, to the longitudinal axis E of the electrode. The formation of the elevation or groove with an angle to the longitudinal axis E of the electrode results in a light spiral on the surface of the electrode, which reduces the frictional resistance when inserting the electrode into the bore.

In an advantageous embodiment, the at least one elevation has a height H in relation to the base body of the electrode. The diameter D_{G} of the base body is smaller at the outer end than the diameter D_{R} of a circumference about the at least one elevation with the longitudinal axis E of the electrode as the center point at the outer end. In particular, the ratio of height H and diameter D_{G} of the base body is less than 0.04% and greater than 0.015%, in particular less than 0.036% and greater than 0.02%. For example, the height H has a value of less than 0.05 mm and greater than 0.02 mm, in particular of 0.03 mm.

In addition, the height H of the elevation from the inner end of the base body may increase towards the outer end of the base body. As a result, the at least one elevation also serves as an insertion aid when the electrode is inserted into the bore and the force with which the electrode is inserted into the bore can be continuously increased. The process of inserting the electrode into the bore is thus more controllable.

Additionally or alternatively, the at least one groove may have a depth T in relation to the base body of the electrode. The diameter D_{G} of the base body at its outer end is larger than the diameter D_{K} of an inner circle within the at least one groove with the longitudinal axis E of the electrode as the center point at the outer end.

In an advantageous embodiment, the base body comprises elongated elevations and grooves which are arranged alternately on the base body along the circumference of the base body. In this example, the base body no longer necessarily has a first section.

If the elevations have a triangular shape and the grooves have a notch shape, then the arrangement and configuration of the elevations and the grooves results in the outer end face of the base body being star-shaped. This on the one hand reduces the frictional resistance of the electrode when inserting the electrode into a bore. Furthermore, the elevations may readily deform plastically and may fill in the volume of the grooves.

The invention furthermore relates to a spark plug having a longitudinal axis X. The spark plug comprises a housing, an insulator arranged within the housing, a center electrode arranged within the insulator, an electrode according to the invention as a ground electrode, a bore having a diameter D_{B} in which the ground electrode is inserted, and an ignition gap that is formed between the ground electrode and the center electrode. The spark plug has the advantage that by using the electrode according to the invention as a ground electrode, the spark plug can be easily and cost-efficiently produced.

In a further development of the spark plug, it is provided that the ground electrode is inserted into the bore and the at least one elevation and/or at least one groove are at least partially plastically deformed by the insertion such that the ground electrode is pressed into the bore.

In a further development, the ground electrode is additionally welded in the bore. This prevents unintended loosening of the ground electrode.

In an alternative embodiment, the spark plug has a cap that is attached to the combustion chamber-side end of the housing. The spark plug is a prechamber spark plug, with the bore in which the ground electrode is inserted formed on the cap or on the housing.

For example, the spark plug or prechamber spark plugs have an M10 or M12 thread on the outer side of the housing adapted to thread the spark plug or prechamber spark plug into a cylinder head.

The bore is typically a through bore and may be formed on the spark plug housing for example.

### BRIEF DESCRIPTION OF THE DRAWINGS

FIG. 1 shows one example of a spark plug and one example of a prechamber spark plug each with a ground electrode inserted

FIG. 2 shows a first example for the electrode according to the invention

FIG. 3 shows a second example for the electrode according to the invention

FIG. 4 shows a third example for the electrode according to the invention

FIG. 5 shows two steps of a manufacturing method for a spark plug 1 according to the invention.

### DETAILED DESCRIPTION

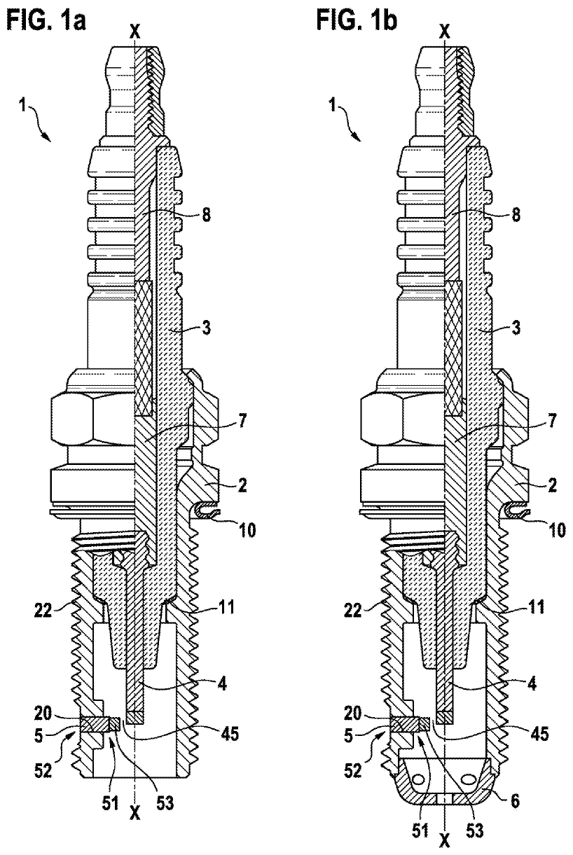

FIG. 1a) shows a spark plug 1 in a semi-sectioned representation. The spark plug has a longitudinal axis X which extends from the end of the spark plug 1 on the combustion chamber side to the end of the spark plug 1 facing away from the combustion chamber. The spark plug 1 has a housing 2 having a longitudinal bore parallel to the longitudinal axis X of the spark plug 1. On its outer side, the housing 2 typically has a thread 22 with which the spark plug 1 can be screwed into a cylinder head. Typically, an outer seal 10 is arranged on the outer side of the housing 2, which seals a transition between the housing 2 and the cylinder head.

The insulator 3 is arranged and attached within the housing 2. The gap between the housing 2 and the insulator 3 is sealed by an internal seal 11. Starting from its end facing away from the combustion chamber, a connecting bolt 8, a resistor element 7 and a center electrode 4 are arranged in the insulator 3 and are electrically contacted with each other. The center electrode 4 typically projects out of the combustion chamber end of the insulator 3 and, in this example, into the interior of the housing 2.

The ground electrode 5 is in particular inserted into a bore 20 formed in the housing wall. The bore 20 is a through-bore that extends from the outer side to the inner side of the housing 2. The ground electrode 5 is rod-shaped and has an inner end 51 and an outer end 52.

The inner end 51 of the ground electrode 5 projects into the interior of the housing. The inner end 51 of the ground electrode 5 forms the ignition gap 45 together with the center electrode 4. In this example, the two electrodes 4, 5 form a radial ignition gap 45. The ground electrode 5 and the center electrode 4 may also be arranged with respect to each other such that they form an axial ignition gap.

The center electrode 4 and/or the ground electrode 5 may each have a precious metal-containing ignition element 53 at their ends delimiting the ignition gap 45. In the case of the ground electrode 5, the precious metal-containing ignition element 53 is then arranged at the inner end 51 of the ground electrode 5.

In an alternative embodiment, which is shown in FIG. 1b), a cap 6 may be arranged on the housing 2 on its combustion chamber-side end face. The housing 2 and the cap 6 together form a prechamber with a prechamber volume. The bore 20, in which the ground electrode 5 is inserted, can be formed in a housing wall or in a cap wall.

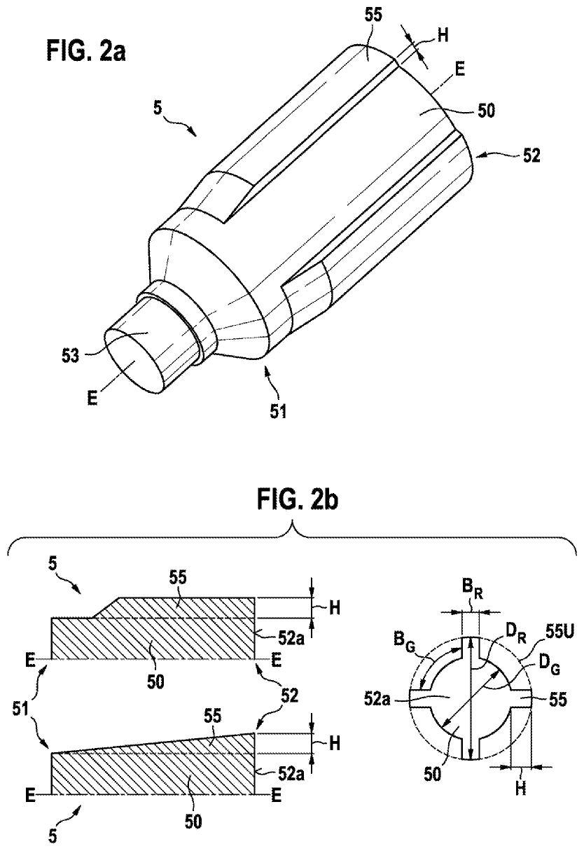

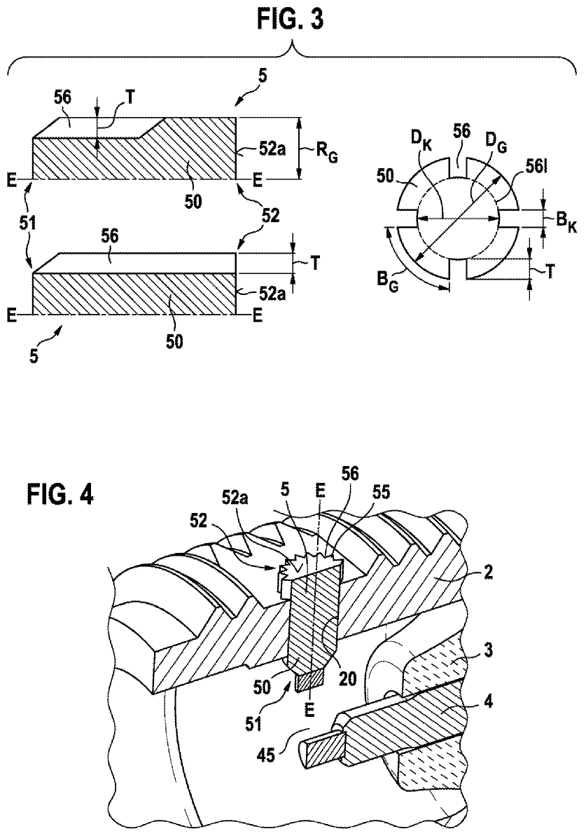

FIG. 2 and FIG. 3 show exemplary embodiments for the electrode according to the invention.

In FIG. 2 a), an exemplary embodiment for an electrode 5 according to the invention is shown in a 3D view. The electrode 5 has a base body 50 on which at least two elongated elevations 55 are arranged along its circumference. The elongated elevations 55 run parallel to the longitudinal axis E of the electrode 5 and the base body 50. The elongated elevations 55 are made of the same material as the base body 50 and are formed by correspondingly shaping a base body blank onto the base body 50. The elongated elevations 55 are formed at least on a partial length of the base body 50. Preferably, they extend over the entire length of the base body 50.

In this example, an element 53 is arranged at the inner end 51 of the electrode 5, forming the ignition surface of the electrode 5. The element 53 can be made of the same material as the base body 50 or of another material, for example a precious metal or a precious metal alloy.

At the outer end 52 of the electrode 5, the elongated elevation 55 has a height H with respect to the surface of the base body 50. Height H may be constant over the length of elevation 55. Alternatively, the height H may increase continuously from the inner end 51 of the elevation 55 to the outer end 52 of the elevation 55. In another alternative, the elevation 55 can have a first area at its inner end 51 at which the height H increases and at which a second area with a constant height H adjoins. The second area then extends from the first area to the outer end 52 of the elevation 55. If, as in this example, the electrode 5 has more than one elongated elevation 55, preferably all elevations 55 are of the same shape.

In FIG. 2 b), the outer end face 52a of the electrode 55 and two side views of the electrode 5 are shown in section. The two side views show two possible configurations for the elongated elevation 55. In both examples, the elongated elevation 55 extends parallel to the longitudinal axis E. The elongated elevation 55 terminates at the outer end 52 of the electrode 5 and the base body 50. In the first example, the elongated elevation 55 has a first area with an increasing height H and a second area with a constant height H. In the second example, the elongated elevation 55 has only a first area with an increasing height H.

The illustration of the outer end face 52a of the electrode 5 shows the resulting shape of the end face 52a. In this example, four elongated elevations 55 having a width B_{R} and a height H are evenly arranged along the circumference of the base body 50. In this example, the electrodes 5 have a diameter D_{R} at the elevations and a diameter D_{G} at the base body. D_{R}>D_{G} applies, and in particular D_{R}=D_{G}+2*H applies. For example, D_{G} has a value of 1.4 mm and D_{R} has a value of 1.48 mm.

As can be seen in the illustration of the outer end face 52a of the electrode 5, the electrode 5 has at least two sections along its circumference. In the first section, the electrode 5 has the diameter D_{G} of the base body 50. In the second section of the electrode 5, the base body 50 has an elevation 55 and a diameter Dr, which deviates from D_{G} correspondingly, which is the diameter of a circumference 55U about the at least one elevation 55. Measured along the circumference of the base body 55, the first section with its length B_{G} is longer than the second section. The length of the second section is the width B_{R} of the elevation 55.

The elevations 55 shown here have a rectangular shape. Other forms are also possible, for example triangular shapes.

FIG. 3 also shows the outer end face 52a of the electrode 5 as well as two side views of the electrode 5 in section for an embodiment of the electrode 5 with grooves 56. Two exemplary embodiments are shown in the side view.

In the first exemplary embodiment, the groove 56 extends from the inner end 51 of the base body 50 to about half of the base body 50. The groove 56 has a first area where the depth increases T, a second area with a constant depth T, and a third area where the depth T decreases. In this example, the outer end face 52a has the diameter D_{G} of the base body, or the radius R_{G} of the base body 50 is drawn.

In the second exemplary embodiment, the groove 56 extends from the inner end 51 of the electrode 5 to the outer end 52 of the electrode 5. The groove 56 has a first section in which the depth T increases and a second area with a constant depth T. The outer end face 52a of the electrode 5 according to this example corresponds to the illustration of the outer end face 52a shown here.

As can be seen in the illustration of the outer end face 52a of the electrode 5, the electrode 5 has at least two sections along its circumference. In the first section, the electrode 5 has the diameter D_{G} of the base body. In the second section of the electrode 5, the base body 50 has a groove and a diameter Dk, which deviates from D_{G} accordingly, which is the diameter of an inner circle 561 within the groove 56. The diameter D_{K} is smaller than the diameter D_{G}, in particular D_{G}=D_{K}+2*T.

Measured along the circumference of the base body 50, the first section with its length B_{G} is longer than the second section. The length of the second section is the width B_{K} of the groove 56.

The grooves 56 shown here have a rectangular shape. Other forms are also possible, for example triangular shapes.

FIG. 4 shows the combustion chamber-side end area of a spark plug 1 according to the invention in a sectioned diagram. The electrode 5 is partially inserted into a bore 20 formed in the housing 2. According to a further embodiment, the electrode 5 has elongated elevations 55 and grooves 56 in the form of notches, which are alternately arranged along the circumference of the base body 50, such that the outer end face 52a of the electrode 5 has the form of a multi-pointed star. During the expansion and pressing of the electrode 5 into the bore 20, the elevations 55 deform plastically and reduce the volume of the grooves 56. This results in a secure attachment of the electrode 5 in the bore 20.

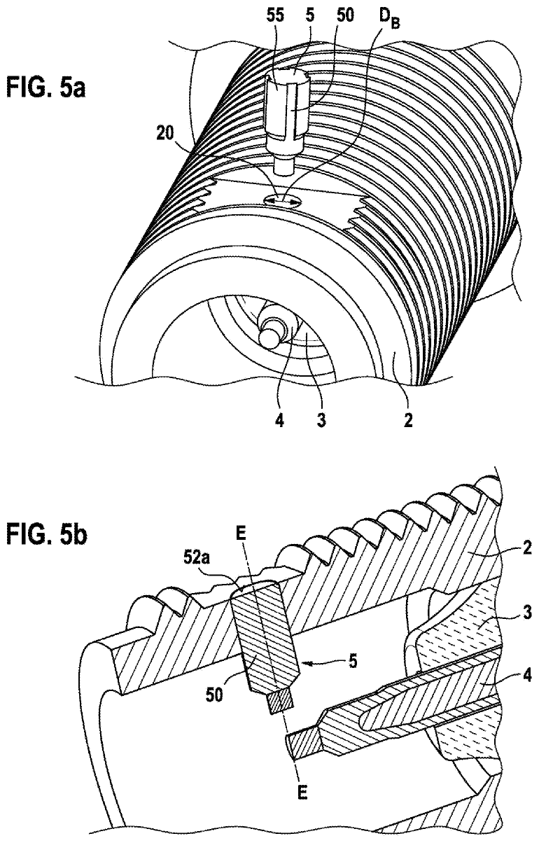

FIG. 5 shows two steps of a manufacturing method for a spark plug 1 according to the invention. In FIG. 5 a), a spark plug 1 is provided without a ground electrode. An electrode 5 according to the invention is provided, which is inserted into the bore 20 formed on the housing 2. The bore 20 has a diameter D_{B} at its outer end.

If the electrode 5 has elevations 55, then the electrode 5 has a diameter D_{G} on the base body 50 and a diameter D_{R} on the elevations 55. For example, the relationship is that D_{R}>D_{G}, D_{G}<D_{B}, and/or D_{R}>D_{B}.

If the electrode 5 has grooves 56, then the electrode 5 has a diameter D_{G} on the base body 50 and a diameter D_{K} within the grooves 56. For example, the relationship is that D_{K}<D_{G}, D_{G}>D_{B} and/or D_{K}<D_{B}.

If the electrode 5 has elevations 55 and grooves 56, then the electrode 5 has a diameter D_{R} for the elevations 55 and a diameter D_{K} in the grooves 56. The relationship then applies here: D_{K}<D_{B}<D_{R}.

In FIG. 5b), the electrode 5 is mounted in the spark plug 1. The elevations 55 and/or grooves 56 have at least partially or completely disappeared due to the plastic deformation during insertion. In particular, the elevations 55 and the grooves 56 are twisted on at least that area of the base body 50 which projects out of the bore 20 into the interior of the housing 2. If necessary, elevations 55 and/or grooves 56 may still be recognizable on the outer end face 52a of the electrode 5.

1. An electrode (5) for a spark plug having a base body (50), a longitudinal axis E, an inner end (51) on which an ignition surface is arranged, and an outer end (52) opposite the inner end, wherein the base body (50) has a diameter D_{G}, wherein the electrode (5) has at least one elongated elevation (55) and/or at least one groove (56) on the base body (50).

2. The electrode (5) according to claim 1, wherein the base body (50) comprises at least two or three or four or five elongated elevations (55) and/or grooves (56) that are evenly arranged along a circumference of the base body (50).

3. The electrode (5) according to claim 1, wherein the at least one elevation (55) and/or the at least one groove (56) extends parallel or at an angle of greater than 0° and less than 90° to the longitudinal axis E of the electrode (5).

4. The electrode (5) according to claim 1, wherein the at least one elevation (56) has a height H with respect to the base body (50) of the electrode (5), and wherein the diameter D_{G} of the base body (50) at the outer end (52) is smaller than a diameter D_{R} of a circumference (55U) around the at least one elevation (55) with the longitudinal axis E of the electrode (5) as a center point at the outer end (52).

5. The electrode (5) according to claim 4, wherein the height H of the at least one elevation (55) increases from the inner end (51) of the base body (50) towards the outer end (52) of the base body (50).

6. The electrode (5) according to claim 1, wherein the at least one groove (56) has a depth T in relation to the base body (50) of the electrode (5), and wherein the diameter D_{G} of the base body (50) at the outer end (52) is larger than a diameter D_{K} of an inner circle (561) within the at least one groove (56) with the longitudinal axis E of the electrode (5) as a center point at the outer end (52).

7. The electrode (5) according to claim 1, wherein the elongated elevations (55) and grooves (56) are arranged alternately on the base body (50) along a circumference of the base body (50).

8. The electrode (5) according to claim 7, wherein an arrangement and configuration of the elevations (55) and the grooves (56) cause an outer end face (52a) of the base body (50) to be star-shaped.

9. A spark plug (1) with a longitudinal axis X, comprising
a housing (2),
an insulator (3) arranged inside the housing (2),
a center electrode (4) arranged inside the insulator (3),
an electrode according to claim 1 a ground electrode (5),
a bore (20) having a diameter D_{B} in which the ground electrode (5) is inserted, and
an ignition gap (45) formed between the ground electrode (5) and the central electrode (4).

10. The spark plug (1) according to claim 9, wherein the ground electrode (5) is inserted into the bore (20) and the at least one elevation (55) and/or at least one groove (56) are at least partially plastically deformed by the insertion such that the ground electrode (5) is pressed into the bore (20).

11. The spark plug (1) according to claim 9, wherein the ground electrode (5) is welded in the bore (20).

12. The spark plug (1) according to claim 9, wherein the spark plug (1) has a cap (6) attached to a combustion-side end of the housing (2) and the spark plug (1) is a prechamber spark plug, wherein the bore (20), in which the ground electrode (5) is inserted, is formed on the cap (6) or on the housing (2).

13. The electrode (5) according to claim 3, wherein the at least one elevation (55) and/or the at least one groove (56) extends parallel or at an angle of greater than 0° and less than 45° to the longitudinal axis E of the electrode (5).
